(19) United States
(12) Patent Application Publication
(10) Pub. No.: US 2023/0312126 A1
(43) Pub. Date: Oct. 5, 2023

(54) INERTING TANK SYSTEM

(71) Applicant: AeroParts Manufacturnig & Repair, Inc., Rio Rancho, NM (US)

(72) Inventor: Jeffrey S. Smith, Coral Springs, FL (US)

(73) Assignee: AeroParts Manufacturnig & Repair, Inc., Rio Rancho, NM (US)

(21) Appl. No.: 18/119,541

(22) Filed: Mar. 9, 2023

Related U.S. Application Data
(60) Provisional application No. 63/318,218, filed on Mar. 9, 2022.

(51) Int. Cl. B64D 37/32; B01D 46/00; B01D 53/86

(52) U.S. Cl. CPC B64D 37/32; B01D 46/003; B01D 53/8675; B01D 2257/104; B01D 2257/106; B01D 2259/4566

(57) ABSTRACT

An inerting fuel tank system comprising a closed tank and any number of flow impingement valves. The flow impingement valve allows uninhibited flow in one direction. In the reverse direction, the fluid flows back into the input flow stream thereby slowing / preventing the fluid flow outward. The flow impingement valve resists reverse flow of fluid out of a fuel tank vent due to sloshing or other flow dynamics.

### CROSS-REFERENCE TO RELATED APPLICATION

This application claims the benefit of U.S. Provisional Pat. Application Ser. No. 63318218 filed Mar. 9, 2022, titled “INERTING TANK SYSTEM” and the subject matter thereof is incorporated herein by reference thereto.

### TECHNICAL FIELD

The present invention relates to fuel tanks, and more specifically, an inerting fuel tank system.

### PRIOR ART

Fuel tanks are susceptible to combustion of flammable materials store in a confined space. When a combustible liquid, commonly gasoline, diesel fuel, aviation fuel, jet fuel, or rocket propellant, is stored in a confined space, there is a space above the fuel, called the ullage. The ullage contains evaporated fuel mixed with air, which contains the oxygen necessary for combustion. This mixture can ignite provided an ignition source exists. An inerting system decreases the probability of combustion by replacing the air with an inert gas such as nitrogen or air of sufficiently reduced oxygen content resulting in nitrogen enriched air which cannot support combustion. Inerting refers to this introduction of an inert gas, such as nitrogen or nitrogen enriched air, into a closed system to make the system non-ignitable.

Fuel tank explosions can cause catastrophic damages and death. The Federal Aviation Administration (FAA) has been tracking fuel tank explosions, specifically those in aircrafts, since 1959. Between 1959 and 2012, 18 fuel tank explosions on transport category aircraft occurred. The most notable event occurring in 1996 in the explosion of a B747-100 series aircraft operating as TWA Flight 800. It was determined that the explosion was the result of ignition of fuel vapor and air in the center wing fuel tank. Although the ignition source was never conclusively identified, the center wing fuel tank (NTSB) concluded there was a flaw in the design and certification philosophy of the FAA with respect to fuel tank flammability. The previous philosophy had been to remove any ignition source from the “fire triangle” (fuel, oxidizer, ignition source). The FAA’s new philosophy concentrated on reducing the oxidizer and effectively controlling the dispersion and confinement legs of the “explosion pentagon” (fuel, oxidizer, ignition source, confinement, dispersion) to prevent further explosions.

Subsequently, the FAA established the Aviation Rulemaking Advisory Committee (ARAC) task force groups to reduce the flammability of fuel tanks as part of a Fuel Tank Harmonization Working Group. One task group was specifically assigned to study the means of reducing on-board fuel tank flammability though On-Board Inert Gas Generation System (OBIGGS). OBIGGS separate nitrogen from engine bleed air. Such systems existed on military aircraft, notably the C-17 as well as some fighters and helicopters. None of the airplanes analyzed had enough engine bleed air available to supply these systems. Several on-board systems were reviewed. Exhaust gas from the jet’s engines and auxiliary power unit (APU) were deemed infeasible primarily because the exhaust contains too much oxygen. Carbon dioxide in gaseous and solid (dry ice) form was also deemed infeasible. Except for nitrogen systems, none of the systems were mature enough to be considered for installation on commercial aircraft.

It was determined that nitrogen systems were the best candidate of this inerting method, and the FAA passed certain regulations relating to the installation of inerting systems on commercial aircraft. As such, aircraft manufacturers contracted their system integrators to create a system to provide nitrogen enriched air to the fuel tanks as a preventative measure for fuel explosion incidents.

This system includes any number of components that can experience irreparable damage once exposed to fuel. The check valves in this system are flapper seal type check valves. The sloshing of fuel can allow fuel to be release through the check valves.

Although simple in nature, these types of check valves having moving parts and require maintenance to ensure long term continued operation. Check valves located in the fuel tanks are extremely difficult to remove when maintenance is required as they are in difficult to access areas. There exists a need for a reliable, cost effective, durable inerting tank system.

The present invention overcomes the shortcomings contained in the prior art by providing an inerting tank system that can be installed on aircrafts, as well as other applications that require an inerting tank system. The present invention is reliable, inexpensive, and durable.

### SUMMARY OF THE INVENTION

The present invention provides an inerting fuel tank system comprising a closed tank and any number of flow impingement valves. Each flow impingement valve allows uninhibited flow in one direction. In the reverse direction, the fluid flows back into the input flow stream thereby slowing / preventing the fluid flow outward. The flow impingement valve resists reverse flow of fluid out of a fuel tank vent due to sloshing or other flow dynamics.

None of the prior art fully addresses the problems resolved by the present invention. The present invention overcomes these limitations contained in the prior art by providing an apparatus that provides the inertization of fuel tank systems that is easy to maintain, cost effective, can be retrofitted to existing fuel tanks, and not susceptible to failure.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF DRAWINGS

FIG. 1 illustrates a block diagram of an inerting fuel tank system.

FIG. 2 illustrates a perspective view of the flow impingement valve of the present invention.

FIG. 3 illustrates a perspective cut-away view of two flow impingement valves in series of the present invention.

FIG. 4 illustrates a top down cut-away view of two flow impingement valves in series of the present invention.

FIG. 5 illustrates a simplified top down cut-away view of two flow impingement valves in series of the present invention showing the flow of a fluid.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

Elements in the figures that are numbered with an apostrophe (’) mean they are corresponding pieces to their counterparts that do not have the apostrophe (’), such as 203 and 203′. The second flow impingement valve and pieces of said second flow impingement valve, if any, are typically denoted with the apostrophe (’). A set of two corresponding pieces, such as 203 and 203′, may be referred to as a “pair” when referring to both pieces.

Dotted lines, if any, in the figures denote parts of the apparatus that are not visible from the current view.

The term “fluid” as used herein includes any substance that flows, including air. In the preferred embodiment, engine bleed air is the fluid that flows through the apparatus of the present invention.

The present invention provides an inerting fuel tank system, comprising an ozone removal device, wherein air flows into the ozone removal device, wherein a valve controls the flow of air into the ozone removal device, wherein the ozone removal device removes ozone from the air; a heat exchanger, wherein air flows from the ozone removal device to the heat exchanger; a filter, wherein air flows from the heat exchanger to the filter; an air separator module, wherein air flows from the filter to the air separator module, wherein heat and pressure sensors are located between the filter and the air separator module; a fuel tank; an oxygen sensor; at least one check valve, wherein the oxygen sensor and the at least one check valve are located between the air separator module and the fuel tank; and at least one flow impingement valve, wherein the at least one flow impingement valve is disposed in the fuel tank, wherein the air separator module removes oxygen from the air and creates nitrogen enriched air which flows into the fuel tank through at least one check valve and the at least one flow impingement valve, wherein the oxygen content of the nitrogen enriched air is measured by bleed off prior to entering the at least one check valve by an oxygen sensor, wherein valves and sensors are placed throughout the system to allow for proper use and to control the flow of the air, and wherein the at least one flow impingement valve partially impedes reverse flow out of the fuel tank while allowing uninhibited flow of the nitrogen enriched air into the fuel tank.

In an alternate embodiment, the present invention comprises a fuel tank; and at least one flow impingement valve, wherein the at least one flow impingement valve is disposed in the fuel tank, wherein the at least one flow impingement valve contains one or more flow impingement blockers, and wherein one or more flow impingement blockers in the at least one flow impingement valve partially impedes reverse flow out of the fuel tank while allowing uninhibited flow into the fuel tank.

The flow impingement valve of the present invention allows uninhibited flow in one direction. In the reverse direction, the fluid flows back into the input flow stream thereby slowing / preventing the fluid flow outward. The flow impingement valve resists reverse flow of fluid out of a fuel tank vent due to sloshing or other flow dynamics. The flow impingement valve of the present invention contains no moving parts.

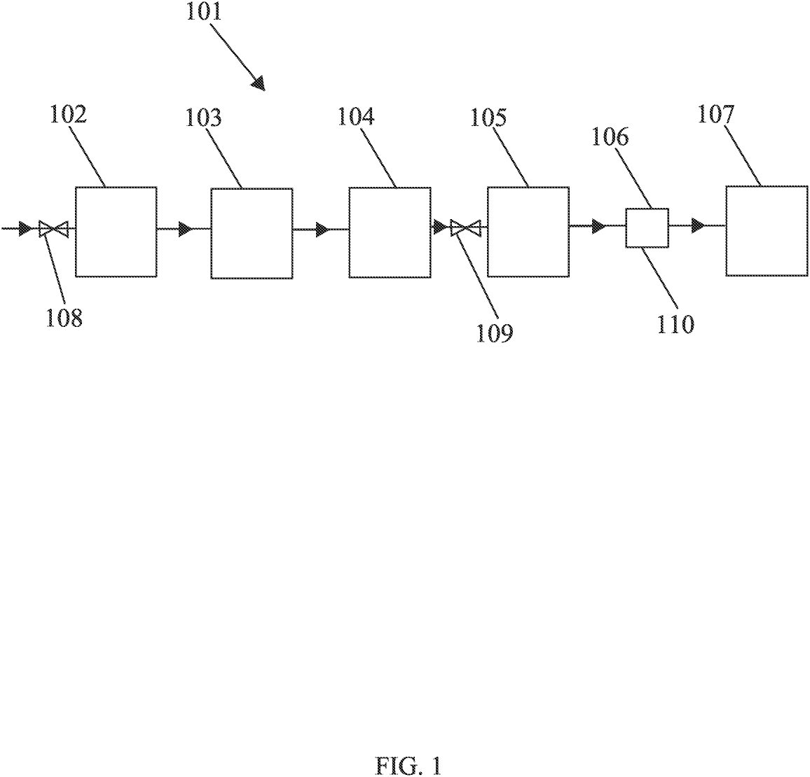

FIG. 1 shows a block diagram of an inerting fuel tank system 101, typically referred to as an OBIGGS. The purpose of the inerting fuel tank system 101, or OBIGGS, is to separate nitrogen from engine bleed air. A fluid flow enters inerting fuel tank system 101 throw valve 108 and enters ozone removal device 102. Ozone removal device 102 removes ozone from the air and is typically a catalytic ozone converter. Valve 108 controls the flow of air into the ozone removal device 102. The fluid then flows to heat exchanger 103 and then to filter 104. Filter 104 may comprise any type of filter that achieves the desired result but is typically a particulate coalesce filter. Valve 109 controls the flow of the fluid between filter 104 and air separator module 105. The air separator module 105 creates nitrogen enriched air, which flows from air separator module 105 through the oxygen sensor 110 and one or more check valves 106 into fuel tank 107. This creates a nitrogen cap in fuel tank 107. Additional valves and sensors are placed throughout inerting fuel tank system 101 to allow for proper use and to control the flow of the air throughout. Pipes or tubing that carry the fluid(s) are present in the inerting fuel tank system 101 and allow the fluid(s) to move throughout inerting fuel tank system 101 from one piece of equipment to the next.

Inerting fuel tank system 101 may comprise any combination of the parts show in FIG. 1. Parts may be added or taken away from the inerting fuel tank system 101 as desired.

The inerting fuel tank system 101 provides one or more check valves 106 that prevent reverse flow of fuel back into the air separator module 105. A typical OBIGGS has two check valves places in between the air separator module 105 and the fuel tank 107.

Inerting fuel tank system 101 shows the primary components of the system, but there are other components present. Inerting fuel tank system 101 may have other components, such as a turbo booster, for example.

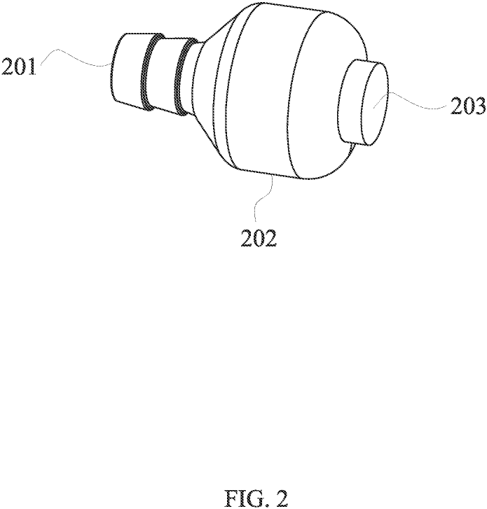

FIG. 2 shows a perspective view of flow impingement valve 202. Flow impingement valve 202 takes the place of one of the one or more check valves 106. Nitrogen enriched air flows from air separator module 105 through the oxygen sensor 110, the one or more check valves 106, and into fuel tank 107 via flow impingement valve 202. Flow impingement valve 202 is disposed in fuel tank 107. All nitrogen enriched air that goes into fuel tank 107 flows through flow impingement valve 202.

Inlet point 203 allows flow of fluid into flow impingement valve 202. Nitrogen enriched air flows through inlet point 203 and into flow impingement valve 202. The nitrogen enriched air enters the fuel tank 107 when it exits flow impingement valve 202 at outlet point 201.

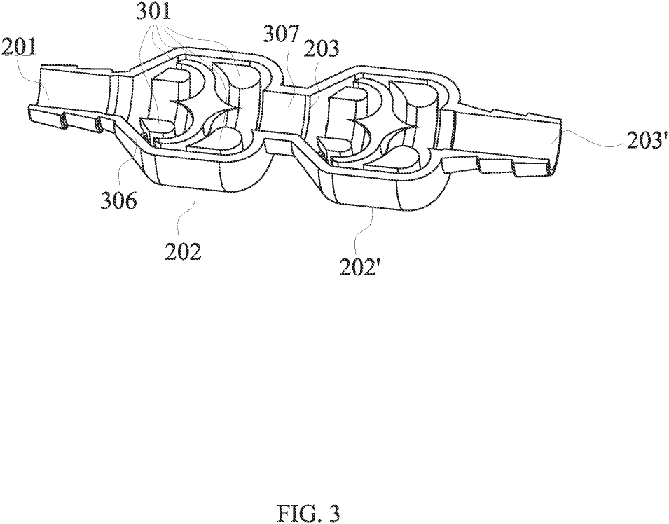

FIG. 3 shows a perspective cut-away view of two flow impingement valves 202 and 202′ in series. Nitrogen enriched air enters flow impingement valve 202′ at inlet point 203′ and then flow impingement valve 202 at inlet point 203.

Flow impingement blockers 301 are placed in the flow impingement valve 202 and create a series of loops that are designed to partially impede reverse flow, while allowing uninhibited flow in the other direction. Flow impingement blockers are present in flow impingement valve 202′, but are not numbered in this Figure. Flow from inlet point 203′ to outlet point 201 is relatively unimpeded.

Flow impingement valves 202 and 202′ are connected at inlet point 203, creating flow impingement valve connection 307. Outlet point 201′ of flow impingement valve 202′ is not shown or numbered as it connects to inlet point 203 of flow impingement valve 202 to form flow impingement valve connection 307. Flow impingement valve 202 and flow impingement valve 202′ are substantially identical. Wall 306 contains the flow of the fluid and the flow impingement blockers 301 and may be any thickness as required.

In the preferred embodiment of the preferred invention, flow impingement valves 202 and 202′ are disposed in an inerting fuel tank system in an aircraft and the fluid that flows through flow impingement valves 202 and 202′ is engine bleed air from the aircraft.

In one embodiment of the present invention, flow impingement valve 202 and flow impingement valve 202′ are not identical and may contain different flow impingement blockers or other mechanisms or devices to achieve the desired result.

Any inlet point of a flow impingement valve of the present invention can be connected to the outlet point another flow impingement valve of the present invention in order to operate in series. When an inlet point is connected to an outlet point, a flow impingement valve connection is formed.

Inlet point 203 and outlet point 201 may comprise any shape that achieves the desired result such that inlet point 203 of flow impingement valve 202 is connectable to outlet point 201′ of flow impingement valve 202′. This can be repeated as many times as desired. Inlet point 203′ and outlet point 201 are show in the FIGS. 3-5 as substantially the same shapes and shapes, but this is not required. Inlet point and outlet point as used herein refer to the points where the fluid enters and leaves the flow impingement valve 202, respectively, but also the part of flow impingement valve 202 that leads to and from the flow impingement blockers 301, respectively. Inlet points 203 and 203′ and outlet points 201 and 201′ can by any shape, size, or length that allow for the fluid to flow as required for flow impingement valves 202 and 202′ to operate efficiently. One outlet point of flow impingement valve may be attachably connected to the inlet point of a second flow impingement valve, and repeated as necessary.

Flow impingement valve connection 307 comprises any connection between two flow impingement valves 202. The connection between two flow impingement valves 202 may comprise any type of connection that allows for a secure connection.

Flow impingement valves 202 and 202′ may be different, and there may be any number of flow impingement valves in the system. Flow impingement valve 202 may comprise any number of flow impingement blockers 301 in any design as is required to achieve the desired result.

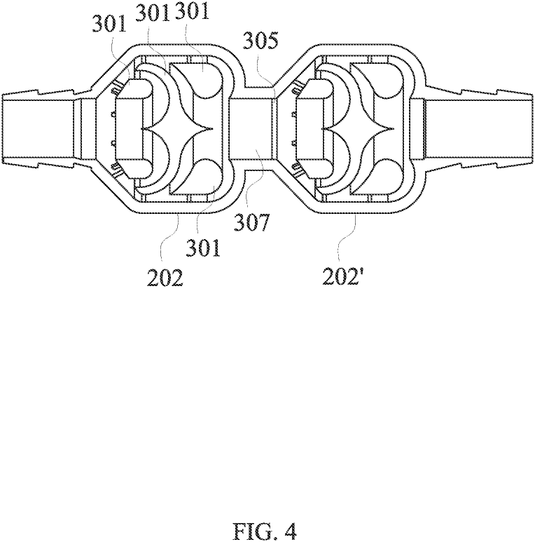

FIG. 4 shows a top down cut-away view of two flow impingement valves 202 and 202′ in series.

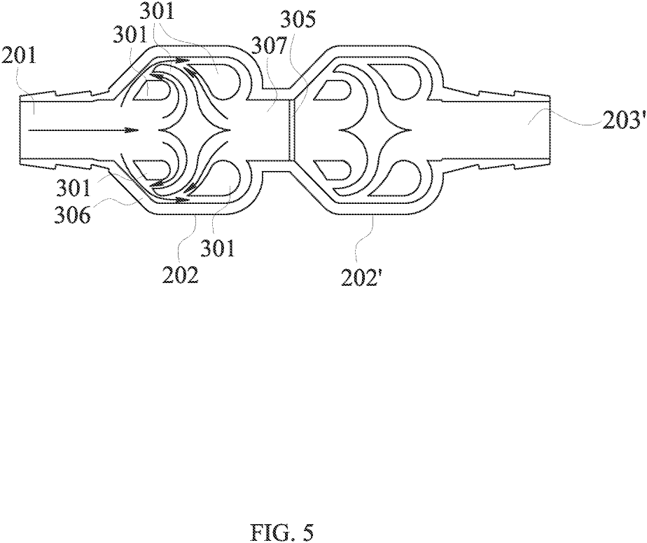

FIG. 5 shows a simplified top down cut-away view of two flow impingement valves 202 and 202′ in series showing the flow of a fluid. The arrows represent the flow of a fluid going in the opposite direction from the nitrogen enriched air that is flowing through inlet point 203′ and into flow impingement valve 202 via flow impingement valve connection 307. The fluid enters flow impingement valve 202 at outlet point 201. Flow impingement blockers 301 are placed in the flow impingement valve 202 and create a series of loops that are designed to slow and prevent the flow of a fluid. As show by the arrows, the fluid flows around the flow impingement blockers 301 in a series of loops, thus slowing the flow of the fluid through flow impingement valve connection 307 and into flow impingement valve 202′. Or in the case where there is only one flow impingement valve 202, the fluid flows around the flow impingement blockers 301 in a series of loops, thus slowing the flow of the fluid through flow impingement valve connection 307 and into another part of the inerting fuel tank system 101. The nitrogen enriched air is flowing in the opposite direction of the fluid, thus further slowing the flow of the fluid.

Flow impingement blockers 301 are not designed to completely stop the flow of the fluid, but instead, the flow impingement blockers 301 slow the flow. Fluid that attempts to go in the way of the arrows is impeded by the flow impingement blockers 301 and the nitrogen enriched air.

Flow impingement valve 202 is disposed in fuel tank 107. In the preferred embodiment, flow impingement valve 202 is placed at an angle of 45 to 90 degrees in relation to the top level plane of fuel tank 107. When flow impingement valve 202 is disposed in fuel tank 107, flow impingement valve 202 is securably attached to fuel tank 107. Any part or parts of flow impingement valve 202 may extend through the wall of fuel tank 107 to the outside of fuel tank 107.

In another embodiment, flow impingement valve 202 is disposed on the top, side, or bottom of fuel tank 107. Multiple Flow impingement valve 202 may be disposed on or in fuel tank 107, either in series or in separate locations. All nitrogen enriched air that goes into fuel tank 107 flows through flow impingement valve 202, regardless of where flow impingement valve 202 is placed.

In the preferred embodiment, nitrogen enriched is pumped through flow impingement valve 202, but any fluid may be pumped through flow impingement valve 202.

The sloshing, or other flow dynamics, can cause the fluid, in this case, fuel, to try and enter flow impingement valve 202 at outlet point 201. However, flow impingement valve 202 resists reverse flow of fluid out of a fuel tank 107. Fluid that attempts to go into flow impingement valve 202 at outlet point 201 is impeded by flow impingement blockers 301. Typical systems have a spring loaded flap type valve with a seal. This can allow reverse flow and is susceptible to breakage due to the moving pieces. The flow impingement valve 202 of the present invention has no moving parts, is not susceptible to breakage, and can be easily retrofitted to existing fuel tanks. This in stark contrast to the commonly used valves, such as flapper type valves, that have moving parts and are susceptible to breakage.

Flow impingement blockers 301 can comprise any design that partially impedes reverse flow, while allowing uninhibited flow in the other direction that has no moving parts.

While the present invention has been described for use with an aircraft, flow impingement valve 202 can be disposed on any system that requires inerting of a tank.

Flow impingement valve 202 can be retrofitted to existing inerting fuel tank system or built in from the beginning.

In another embodiment of the present invention, any number of flow impingement blockers 301, in any shape, are present in flow impingement valve 202 to achieve the desired result.

In another embodiment of the present invention, any number of flow impingement valves are disposed on a tank to achieve the desired result.

Flow impingement valve 202 can be installed on pre-existing tanks or can be installed during the original manufacture of tanks.

For simplicity, certain lines that show the depth and shape of flow impingement valves 202 and 202′ have been omitted in FIG. 5.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. An inerting fuel tank system, comprising:
an ozone removal device,
wherein air flows into the ozone removal device,
wherein a valve controls the flow of air into the ozone removal device,
wherein the ozone removal device removes ozone from the air;
a heat exchanger,
wherein air flows from the ozone removal device to the heat exchanger;
a filter,
wherein air flows from the heat exchanger to the filter;
an air separator module,
wherein air flows from the filter to the air separator module,
wherein heat and pressure sensors are located between the filter and the air separator module;
a fuel tank;
an oxygen sensor;
at least one check valve,
wherein the oxygen sensor and the at least one check valve are located between the air separator module and the fuel tank; and
at least one flow impingement valve,
wherein the at least one flow impingement valve is disposed in the fuel tank,
wherein the air separator module removes oxygen from the air and creates nitrogen enriched air which flows into the fuel tank through at least one check valve and the at least one flow impingement valve,
wherein the oxygen content of the nitrogen enriched air is measured by bleed off prior to entering the at least one check valve by an oxygen sensor,
wherein valves and sensors are placed throughout the system to allow for proper use and to control the flow of the air, and
wherein the at least one flow impingement valve partially impedes reverse flow out of the fuel tank while allowing uninhibited flow of the nitrogen enriched air into the fuel tank.

2. The inerting fuel tank system of claim 1, wherein the filter is a particulate coalesce filter.

3. The inerting fuel tank system of claim 1, wherein the at least one flow impingement valve contains one or more flow impingement blockers.

4. The inerting fuel tank system of claim 1, wherein the oxygen sensor located between the air separator module and the fuel tank measures the amount of oxygen in the nitrogen enriched air in the fuel tank.

5. The inerting fuel tank system of claim 1, wherein the air that flows into the ozone removal device is engine bleed air.

6. The inerting fuel tank system of claim 1, wherein the ozone removal device is a catalytic ozone converter.

7. The inerting fuel tank system of claim 1, wherein the at least one flow impingement valve contains no moving parts.

8. The inerting fuel tank system of claim 1, wherein the at least one flow impingement valve is disposed at an angle.

9. The inerting fuel tank system of claim 1, wherein the angle is 45 to 90 degrees in relation to the top level plane of the fuel tank.

10. The inerting fuel tank system of claim 1, wherein the at least one flow impingement valve is disposed on the side of the fuel tank.

11. The inerting fuel tank system of claim 1, wherein the at least one flow impingement valve is disposed on the top of the fuel tank.

12. The inerting fuel tank system of claim 1, wherein the at least one flow impingement valve is disposed on the outside of the fuel tank and provides access into the fuel tank.

13. An inerting fuel tank system, comprising:
a fuel tank; and
at least one flow impingement valve,
wherein the at least one flow impingement valve is disposed in the fuel tank,
wherein the at least one flow impingement valve contains one or more flow impingement blockers, and
wherein one or more flow impingement blockers in the at least one flow impingement valve partially impedes reverse flow out of the fuel tank while allowing uninhibited flow into the fuel tank.

14. The inerting fuel tank system of claim 13, wherein the at least one flow impingement valve is disposed at an angle.

15. The inerting fuel tank system of claim 13, wherein the angle is 45 to 90 degrees in relation to the top level plane of the fuel tank.

16. The inerting fuel tank system of claim 13, wherein nitrogen or nitrogen enriched air flows into the fuel tank through the at least one flow impingement valve.
